(19) United States
(12) Patent Application Publication
(10) Pub. No.: US 2025/0293816 A1
(43) Pub. Date: Sep. 18, 2025

(54) MANAGING HARQ TRANSMISSIONS IN MULTICAST COMMUNICATION

(71) Applicant: GOOGLE LLC, Mountain View, CA (US)

(72) Inventor: Kao-Peng Chou, Taoyuan City (TW)

(21) Appl. No.: 18/860,447

(22) PCT Filed: Apr. 25, 2023
(86) PCT No.: PCT/US23/19857

§ 371 Date: Oct. 25, 2024

Related U.S. Application Data
(60) Provisional application No. 63/334,348, filed on Apr. 25, 2022.

(51) Int. Cl. H04L 1/1829; H04L 1/1812; H04W 72/21

(52) U.S. Cl. CPC H04L 1/1861; H04L 1/1812; H04W 72/21

(57) ABSTRACT

A user equipment (UE) can implement a method for reporting feedback for a multicast and/or broadcast service (MBS) when the UE is receiving multiple MBSs. The method may include receiving (402), during a time period when a base station generates a sequence of downlink assignments for the multiple MBSs, a plurality of downlink assignments included in the sequence of the downlink assignments, the plurality of downlink assignments scheduling a respective plurality of data transmissions of the MBS service; attempting to receive (404), from the base station, the plurality of data transmissions in accordance with the plurality of downlink assignments; and transmits (406), to the base station, feedback for the plurality of data transmissions, the feedback including an indication of a last successfully received downlink assignment of the plurality of downlink assignments.

### CROSS-REFERENCE TO RELATED APPLICATION

This application claims priority to and the benefit of the filing date of provisional U.S. Patent Application No. 63/334,348, titled “Managing HARQ Transmissions in Multicast Communication,” filed on Apr. 25, 2022. The entire contents of the provisional application are hereby expressly incorporated herein by reference.

### FIELD OF THE DISCLOSURE

This disclosure relates to wireless communications and, more particularly, to support feedback mechanisms for reception of multiple multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul, in what is referred to as dual connectivity (DC) operation. These network nodes may all be nodes using the same radio access technology (RAT), or may include nodes using different RATs. Example DC configurations include NR-only dual connectivity (NR-DC) and EUTRA and NR dual connectivity (EN-DC). When a UE operates in DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, i.e., single connectivity (SC). The UE in SC only communicates with the MN (via the MCG). One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station or a disaggregated base station), interconnected by a backhaul.

UEs can use several types of SRBs and DRBs. So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in single connectivity (SC) or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UF. The UE may perform PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS), also known as MBMS for “multimedia broadcast multicast service,” to UEs that can be useful in many content delivery applications, such as transparent IPv4/IPv6 multicast delivery, IPTV, software delivery over wireless, group communications, IoT applications, V2X applications, and emergency messages related to public safety.

To provide an MBS service, a base station can configure a group of UEs with a common frequency resource (CFR) and a physical downlink control channel (PDCCH) configuration that configures a common PDCCH for the group. The base station can assign a radio network temporary identifier (RNTI) associated with the MBS service to this UE group, which each UE can utilize to receive physical downlink shared channel (PDSCH) transmissions, including MBS data packet(s). The RNTI may be, for example, an MBS-RNTI, a group RNTI (G-RNTI), a group configured scheduling RNTI (G-CS-RNTI), a multicast RNTI (M-RNTI), or a single cell RNTI (SC-RNTI). For ease of explanation, this disclosure will refer to such an RNTI as a G-RNTI. To schedule PDSCH transmissions of MBS data for an MBS service, the base station can transmit downlink control information (DCI), with a cyclic redundancy check (CRC) scrambled using the G-RNTI for the MBS service, on the common PDCCH.

When receiving unicast transmissions, UEs can report feedback using hybrid automatic repeat request (HARQ) mechanisms. To report feedback for a collection of DCI reception occasions (e.g., received during a time window), a UE can transmit a HARQ codebook, a sequence of bits constructed using ACK/NACK feedback for the DCI reception occasions. A type-1 codebook has a fixed size, where a type-2 codebook has a dynamic size.

There are technical challenges for implementing hybrid automatic repeat request (HARQ) mechanisms for MBS reception. For example, 3GPP has recently discussed supporting a dynamic HARQ feedback mechanism (i.e., configuring UEs to utilize type-2 HARQ codebook). However, it is not clear how a UE should structure HARQ feedback, and how a base station should construct an uplink grant for reporting HARQ feedback, in cases where the base station is providing more than one MBS service.

### SUMMARY

Generally speaking, a UE and/or a base station implement the techniques of this disclosure for reporting feedback (e.g., HARQ feedback) related to reception of multiple MBS services.

One example embodiment of these techniques is a method implemented in a UE for reporting feedback for a multicast and/or broadcast service (MBS) when the UE is receiving multiple MBSs. The method may be implemented by processing hardware and includes receiving, during a time period when a base station generates a sequence of downlink assignments for the multiple MBSs, a plurality of downlink assignments included in the sequence of the downlink assignments, the plurality of downlink assignments scheduling a respective plurality of data transmissions of the MBS service; attempting to receive, from the base station, the plurality of data transmissions in accordance with the plurality of downlink assignments; and transmitting, to the base station, feedback for the plurality of data transmissions, the feedback including an indication of a last successfully received downlink assignment of the plurality of downlink assignments.

Another example embodiment of these techniques is a UE including processing hardware configured to execute the method above.

Yet another example embodiment of these techniques is a method in a base station for station for receiving feedback for a multicast and/or broadcast service (MBS) when the base station is transmitting multiple MBSs. The method may be implemented by processing hardware and includes transmitting, to the UE, during a time period when the base station generates a sequence of downlink assignments for the multiple MBSs, a plurality of downlink assignments included in the sequence of downlink assignments, the plurality of downlink assignments scheduling a respective plurality of data transmissions of the MBS; transmitting, to the UE, the plurality of data transmissions in accordance with the plurality of downlink assignments; and receiving, from the UE, feedback for the plurality of data transmissions, the feedback including an indication of a last successfully received downlink assignment of the plurality of downlink assignments.

Still another embodiment of these techniques is a base station including processing hardware configured to execute the method above.

### BRIEF DESCRIPTION OF THE DRAWINGS

FIG. 1A is a block diagram of an example system in which a radio access network (RAN) and a user device can implement the techniques of this disclosure for managing HARQ transmissions in multicast communication;

FIG. 1B is a block diagram of an example base station in which a centralized unit (CU) and a distributed unit (DU) can operate in the system of FIG. 1A;

FIG. 2 is a block diagram of an example protocol stack, according to which each of the UEs of FIG. 1A can communicate with base stations of FIG. 1A;

FIG. 3A is a messaging diagram of an example scenario in which a base station of the RAN of FIG. 1A broadcasts or multicasts system information to the UE, enabling the UE to receive MBS data packets using a HARQ process;

FIG. 3B is a messaging diagram of an example scenario in which a base station of the RAN of FIG. 1A transmits RRC messages to the UE, enabling the UE to receive MBS data packets using a HARQ process:

FIG. 4 is a flow diagram of an example method for transmitting feedback for an MBS when a UE is receiving multiple MBSs, which can be implemented in a UE of FIG. 1A;

FIG. 5 is a flow diagram of an example method for receiving feedback for an MBS when a base station is transmitting multiple MBSs, which can be implemented in a base station of FIG. 1A or 1B.

### DETAILED DESCRIPTION OF THE DRAWINGS

Generally speaking, the techniques of this disclosure allow UEs to utilize a dynamic HARQ feedback mechanism to report feedback related to reception of more than one MBS service. As noted above, 3GPP has recently discussed configuring UEs to utilize a type-2 HARQ codebook for reporting feedback when receiving multiple MBS services. For unicast transmissions or a single MBS service, if configuring a UE to utilize a type-2 HARQ codebook, a base station also indicates a downlink assignment index (DAI) in downlink assignments (e.g., DCIs having DCI format 1_1) scheduling PDSCH transmissions. A DAI conventionally has two bits, such that the value of the DAI can range from 1 to 4. Thus, if transmitting six transport blocks on six PDSCH occasions, the downlink assignments (i.e., DCIs) scheduling these respective six transport blocks will include respective DAI values 1, 2, 3, 4, 1, and 2. Further, to schedule the UE to multiplex HARQ feedback for multiple PDSCH receptions on the same Physical Uplink Shared Channel (PUSCH) resource (i.e., report the HARQ feedback for a collection of PDSCH receptions in a single type-2 HARQ codebook), the base station also transmits an uplink grant (e.g., DCI format 0_1) with an uplink DAI (UL-DAI) field. In this legacy DAI mechanism, the UL-DAI indicates the total number of transmitted transport blocks associated with the codebook, which can increase the reliability of the HARQ feedback if there are any downlink assignments missing before the uplink grant. Based on the received DAI values included in the downlink assignments and the UL-DAI, the UE can identify the number of transmitted downlink assignments and the DAI values of missing downlink assignments, and generate a type-2 HARQ codebook.

In the case of multiple MBS services, a base station can indicate to a UE to multiplex HARQ feedback for multiple MBS services (i.e., for multiple G-RNTIs) on the same PUSCH resource. The type-2 HARQ codebook can include multiple sub-codebooks for each MBS service, concatenated together to form the codebook, 3GPP has agreed that each MBS service (i.e., each G-RNTI) should be associated with separate, or independent, DAI counters. For example, if transmitting downlink assignments for two MBS services over several PDCCH occasions, at each occasion, the base station can transmit one or both of a downlink assignment scheduling the first MBS service and a downlink assignment scheduling the second MBS service. DAI values included in downlink assignments scheduling the first MBS service will cycle from 1-4, and DAI values included in the downlink assignments scheduling the second MBS service will also independently cycle from 1-4. To schedule the UE to multiplex the generated type-2 HARQ codebook in a PUSCH transmission, the base station sends, to the UE, an uplink grant (e.g., DCI format 0_1). 3GPP has recently agreed to use one UL-DAI to support multiple separate DAI counters, each DAI counter corresponding to an MBS service. However, it is not clear how a base station can use a single UL-DAI to convey information for multiple, separate DAI counters. For example, as noted above, a legacy UL-DAI indicates the total number of transmitted transported code blocks associated with a codebook (i.e., with a single DAI counter). If a type-2 HARQ codebook includes multiple sub-codebooks associated with multiple, respective MBS services, it is not clear what information the single UL-DAI should convey such that the UE can report meaningful HARQ feedback, and how the UE should structure the type-2 HARQ codebook.

If, for example, the UL-DAI in multiple MBS scenarios indicates the sum of the total number of transmitted transport blocks (i.e., the sum of DAIs for all of the MBS services), this has the potential to introduce errors. For example, if a UE misses a last DL DCI of at least one of the MBS services, the UE may miscalculate the associated sub-codebook size, and may therefore generate a codebook that the base station cannot read. To address this problem, the UE can append additional information into the sub-codebooks, as will be discussed in further detail below.

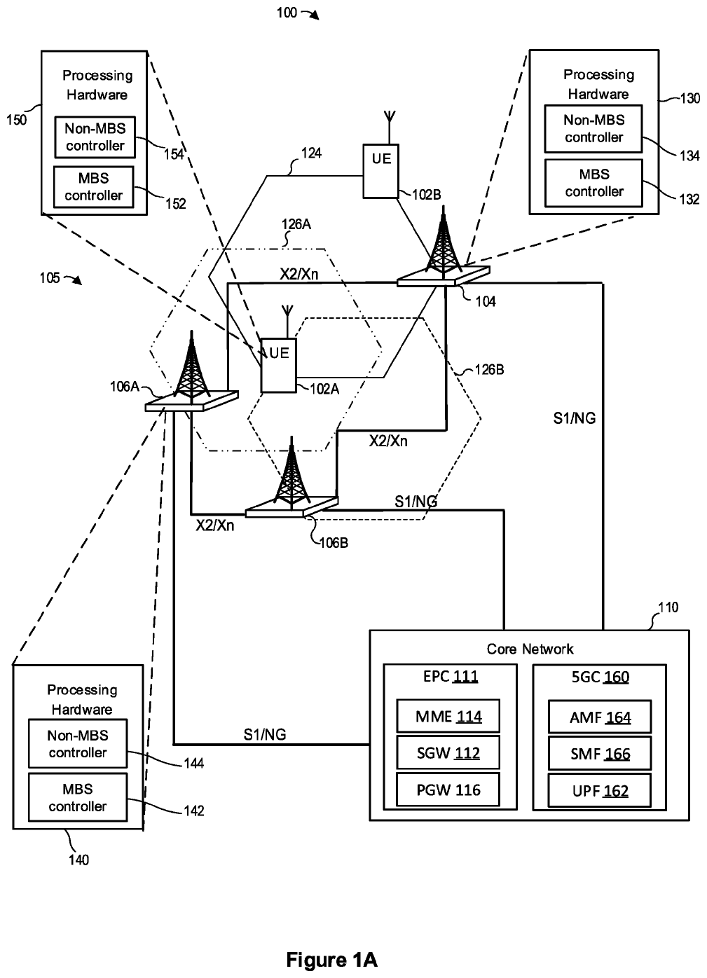

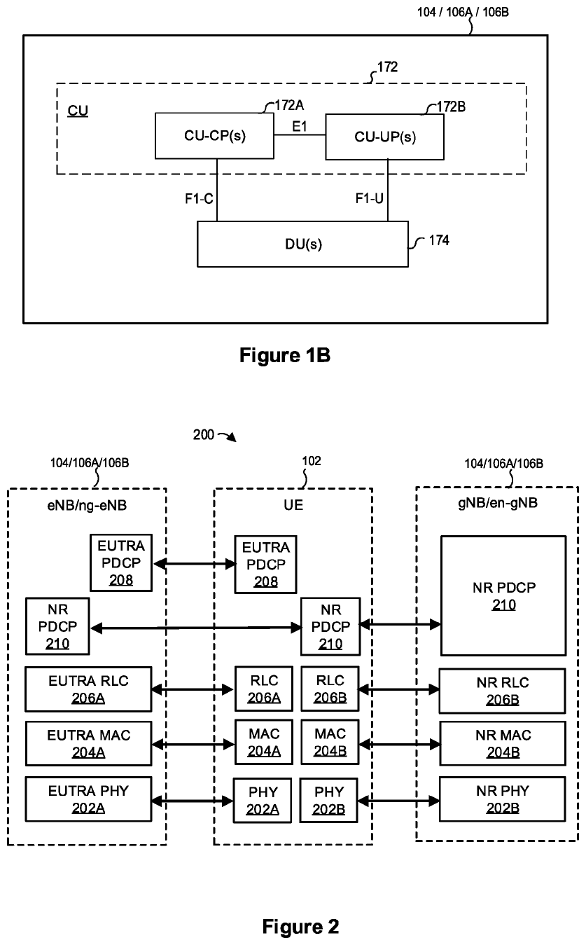

Before describing the specific techniques of this disclosure, an example wireless communication system 100 which can perform these techniques is described with respect to FIG. 1A. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the various dual connectivity (DC) scenarios discussed below. For example, the UE 102 can communicate in DC with the base station 104 (operating as an MN) and the base station 106A (operating as an SN) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106A). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the UL (from the UE 102 to a base station) and/or DL (from a base station to the UE 102) direction. In the non-MBS operation, the UE 102 transmits data via the radio bearer on (i.e., within) an UL bandwidth part (BWP) of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s) or a random access response on the DL BWP.

In MBS operation, the UE 102 can use a radio bearer (e.g., a DRB or an MBS radio bearer (MRB)) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the DL (from a base station to the UE 102) direction. In other implementations, the base station (e.g., the MN or SN) can transmit MBS data over common radio resources (i.e., the radio resources common to the UE 102 and other UE(s)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can apply no security key to MBS data and transmit the MBS data on the radio bearer. Correspondingly, the UE 102 can apply no security key to MBS data received on the radio bearer. Alternatively, the base station can apply common security key(s) (i.e., the security key(s) are common for UEs including the UE 102) to MBS data and transmit the MBS data on the radio bearer. The UE 102 can apply an application-level security key, received from the CN 110 or an MBS server, to MBS data received on the radio bearer.

In the non-MBS operation, the UE 102 can be in a connected state. Alternatively, the UE 102 can be in an idle or inactive state if the UE 102 supports small data transmission in the idle or inactive state. In the MBS operation, the UE 102 can be in a connected state, idle or inactive state.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS data packet(s) received from the CN 110 or an edge server. For example, the base station MBS controller 132 can be configured to support Radio Resource Control (RRC) configurations, procedures and messaging associated with MBS procedures, HARQ, and/or to support the necessary operations, as discussed below. The processing hardware 130 can include a base station non-MBS controller 134 configured to manage or control one or more RRC configurations and/or RRC procedures, HARQ, and/or to support the necessary operations when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS data packet(s) received from the CN 110 or an edge server. For example, the base station MBS controller 142 can be configured to support RRC configurations, procedures and messaging associated with MBS procedures, HARQ, and/or to support the necessary operations, as discussed below. The processing hardware 140 can include a base station non-MBS controller 144 configured to manage or control one or more RRC configurations and/or RRC procedures, HARQ, and/or to support the necessary operations when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS data packet(s). For example, the UE MBS controller 152 can be configured to support RRC configurations, procedures and messaging associated with MBS procedures, HARQ, and/or to support the necessary operations, as discussed below. The processing hardware 150 can include a UE non-MBS controller 154 configured to manage or control one or more RRC configurations and/or RRC procedures, HARQ, and/or to support the necessary operations in accordance with any of the implementations discussed below, when the UE 102 communicates with an MN and/or a SN during a non-MBS operation. The processing hardware 150 in the example implementation of FIG. 1A can also include a soft buffer (not shown) to store HARQ transmissions received from a base station.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (S-GW) 112, a Mobility Management Entity (MME) 114, and a Packet Data Network Gateway (P-GW) 116. The S-GW 112 is generally configured to transfer user-plane packets related to audio calls, video calls, Internet traffic, etc., and the MME 114 is configured to manage authentication, registration, paging, and other related functions. The P-GW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is a Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a centralized unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications. IoT applications. V2X applications, emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2), a DRB or a MRB. The SN-terminated bearer can be an SRB, a DRB or a MBS radio bearer (MRB).

In some implementations, a base station (e.g., base station 104, 106A or 106B) broadcasts MBS data packets via one or more MRBs, and in turn the UE 102 receives the MBS data packets via the MRB(s). The base station can include configuration(s) of the MRB(s) in MBS configuration parameters described below. In some implementations, the base station transmits the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208. RLC sublayer 206. MAC sublayer 204, and PHY sublayer 202, and correspondingly, the UE 102 uses PHY sublayer 202. MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station broadcasts the MBS data packets via the SDAP sublayer 212. PDCP sublayer 208, RLC sublayer 206, MAC sublayer 204 and PHY sublayer 202, and correspondingly, the UE 102 uses PHY sublayer 202. MAC sublayer 204, RLC sublayer 206, PDCP sublayer 208, and the SDAP sublayer 212 to receive the MBS data packets.

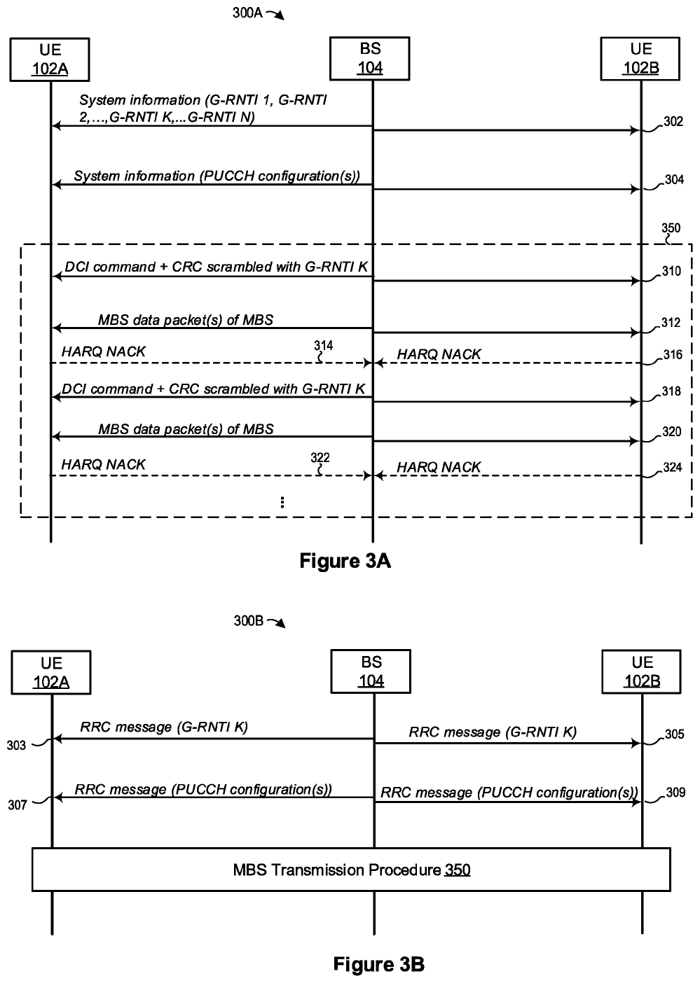

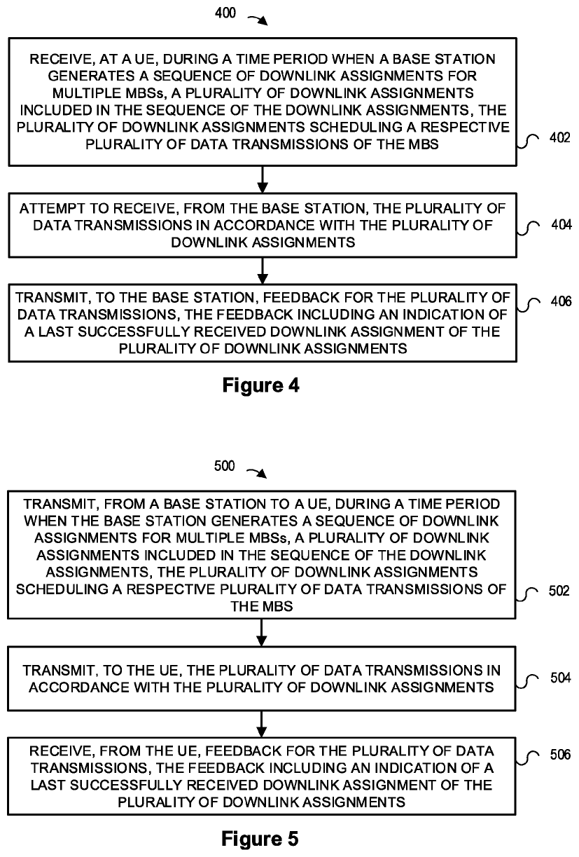

Turning to FIGS. 3A-3B, these figures illustrate scenarios in which a base station transmits (i.e., broadcasts or multicasts) MBS data of an MBS service to one or more UEs, and the UEs provide HARQ feedback for the MBS service. Multi-MBS service operation is discussed in further detail below with respect to FIGS. 4-5.

Now referring to a scenario 300A illustrated in FIG. 3A, the UE 102 (i.e., UE 102A and UE 102B) initially operates in connected state (e.g., RRC_CONNECTED state), or more generally in a state in which there is an active radio connection between the UE 102 and the base station 104. Generally, the base station 104 provides to the UE 102 a configuration of resources for (i) receiving MBS data packet(s) in a downlink direction from the base station 104 and (ii) transmitting an indication of whether the UE 102 successfully received the MBS data packet(s) in an uplink direction to the base station 104.

Base station (BS) 104 transmits (i.e., multicast or broadcast) 302 system information including G-RNTIs, where each G-RNTI is associated with an MBS service, to the UE 102 on cell 124. The base station 104 transmits the G-RNTIs to the UE 102 at event 302 so that later on, when the base station 104 transmits MBS data packet(s) during a HARQ process, the UE 102 can use at least one of the G-RNTIs for decoding purposes to successfully receive the MBS data packet(s). The G-RNTIs can include G-RNTIs 1, 2, . . . . K . . . . N, where K and N are integers and 0<K≤N. For example, N can be 16, 32, 64 or 128. In some implementations, each of the G-RNTIs is different than a cell RNTI (C-RNTI) that the base station 104 can use for unicast communication with the UE 102 (i.e., a C-RNTI dedicated for the UE 102). In some implementations, and as noted above, each of the G-RNTIs can be a G-CS-RNTI, MBS-RNTI, M-RNTI, or SC-RNTI.

In some implementations, the base station 104 can assign each of the G-RNTIs for one or more particular MBSs (e.g., a first MBS, a second MBS, a third MBS, etc.). For example, the one or more MBSs can be for a respective application (e.g., the first MBS is for IPTV, the second MBS is for emergency message delivery, and the third MBS is for a V2X application). As another example, the one or more MBSs can for a single application (e.g., the first MBS is for a first channel of IPTV), the second MBS is for a second channel of IPTV, and the third MBS is for a third channel of IPTV. In some implementations, the base station 104 associates a particular MBS to only one particular G-RNTI (e.g., a first MBS is associated to only G-RNTI K). In other implementations, the base station 104 can associate a particular MBS to more than one G-RNTI (e.g., a first MBS is associated to G-RNTI K and G-RNTI L).

The base station 104 transmits 304 system information including one or more physical uplink control channel (PUCCH) configurations to the UE 102 on cell 124. In some implementations, the base station 104 can transmit 304 PUCCH configuration(s) at the same or different time instances as the G-RNTIs of event 302. In some implementations, the base station 104 can transmit 302, 304 the G-RNTIs and PUCCH configuration(s) periodically. In some implementations, each of the PUCCH configuration(s) can configure, or indicate for the UE 102 one or more PUCCH resources which includes at least one of the following configuration parameters: starting physical resource block (PRB) and/or PRB offset, intra-slot frequency hopping, second-Hop PRB, first symbol (i.e., starting symbol), number of symbols, initial cyclic shift index, number of PRBs, time-domain orthogonal cover code (OCC). OCC length, OCC index, inter-slot frequency hopping, a maximum code rate, number of slots, a modulation and coding scheme, PUCCH format(s), and PUCCH power control. In some implementations, each of the PUCCH configuration(s) is an information element (IE) that is different than a PUCCH-ConfigCommon IE that the base station 104 can broadcast in a System Information Block Type 1 (SIB1) on the cell 124. The base station 104 provides the PUCCH configuration(s) to the UE 102 at event 304 so that later on, if the UE 102 fails to successfully receive MBS data packet(s) from the base station 104, the UE 102 can consequently notify the base station 104 on a PUCCH corresponding to at least one of the PUCCH configuration(s) pursuant to the HARQ process.

As will be discussed in further detail below, in some scenarios, the base station 104 assigns the same PUCCH resource and the same HARQ feedback timing for reporting feedback related to multiple DCIs. In such cases, the UE 102 can generate and multiplex HARQ feedbacks of these DCIs in a HARQ codebook (e.g., a type-2 HARQ feedback). Further, instead of causing the UE 102 to transmit the HARQ feedback at the scheduled PUCCH resource, the base station 104 can schedule the UE 102 to multiplex the HARQ feedback and transmit the HARQ codebook on a PUSCH resource by transmitting an uplink grant to the UE 102 (e.g., DCI format 0_1). The base station 104 can transmit the uplink grant with a CRC scrambled with a C-RNTI of the UE.

In some implementations, the system information of events 302 and 304 can be the same system information, e.g., the same system information block (SIB). In other implementations, the system information of events 302 and 304 can be different system information, e.g., different SIBs. The base station 104 can transmit 302, 304 the system information in any order.

In some implementations, the base station 104 can assign a specific PUCCH configuration for each of the G-RNTIs. That is, each G-RNTI is associated to a specific PUCCH configuration. In other implementations, the base station 104 can assign a single PUCCH configuration for all of the G-RNTIs. In yet other implementations, the base station 104 can assign a first PUCCH configuration for a first group of G-RNTIs (e.g., G-RNTI 1, G-RNTI 2), a second PUCCH configuration for a second group of G-RNTIs (e.g., G-RNTI 3, G-RNTI 4, . . . . G-RNTI K), . . . an X-th PUCCH configuration for an X-th group of G-RNTIs (e.g., G-RNTI K+1, . . . G-RNTI N), where each group has one or more different G-RNTIs.

After broadcasting 302, 304 the system information, the base station 104 obtains MBS data packet(s) (e.g., of a first MBS) and prepares to transmit, to the UE 102, the MBS data packet(s) in a HARQ transmission pursuant to the HARQ process. Because the UE 102 may not be aware of any HARQ process information to successfully receive the HARQ transmission from the base station 104, the base station 104 transmits 310 such HARQ process information to the UE 102 before transmitting the MBS data packet(s). In some implementations, the base station 104 generates a DCI command which assigns a downlink resource, such as a physical downlink shared channel (PDSCH), so that the base station 104 can transmit the MBS data packet(s) to the UE 102 on the PDSCH. In these implementations, the base station 104 can generate a cyclic redundancy check (CRC) for the DCI command and scramble the CRC with any one of the G-RNTI (e.g., G-RNTI K) transmitted to the UE 102 at event 302 to obtain a scrambled CRC. As described herein with respect to FIG. 3A, the particular G-RNTI can be G-RNTI K, but it should be understood that the particular G-RNTI can be any one of the G-RNTIs described in event 302. The base station 104 can transmit 310 the DCI command and the CRC scrambled with the G-RNTI K to the UE 102 on a physical downlink control channel (PDCCH). The scrambled CRC can be upended to or otherwise associated with the DCI command, in some implementations. The UE 102 de-scrambles the received scrambled CRC using the G-RNTI (e.g., G-RNTI K) received at event 302, so that the UE 102 can recognize (and be aware of) the PDSCH assigned by the DCI command on which the base station 104 will transmit MBS data packet(s).

After transmitting 310 the DCI command and the scrambled CRC, the base station 104 transmits 312 the MBS data packet(s) in a HARQ transmission pursuant to the HARQ process on the PDSCH. If the UE 102 successfully receives the MBS data packet(s)) at event 312, the UE 102 in some implementations can transmit a HARQ acknowledgement (ACK) to the base station 104. In other implementations, the UE 102 need not transmit the HARQ ACK.

However, e.g., in poor signal conditions, the UE 102 may not successfully receive the DCI(s) at event 310 or MBS data packet(s) at event 312. Accordingly, pursuant to the HARQ process, the UE 102 transmits 314 a HARQ negative acknowledgement (NACK) to the base station 104. The UE 102 may transmit 314 the HARQ NACK on a PUCCH determined from a PUCCH resource indicated by DCI(s) at event 310, which is associated with the PUCCH configuration(s) received at event 304. If the UE 102 received multiple PUCCH configurations at event 304, the UE 102 in some implementations identifies a specific PUCCH configuration associated to the G-RNTI K and determines the PUCCH in accordance with the specific PUCCH configuration.

In some implementations, the PUCCH determined by the UE 102A and UE 102B can be the same if the UE 102A and the UE 102B received the same PUCCH configuration(s) from the base station 104 at event 304. Therefore, and in contrast to scenarios in which the UE 102 (i.e., each of the UE 102A and 102B) may be assigned unique UL radio resources (time/frequency) to transmit HARQ feedback in response to successfully receiving (or not successfully receiving) unicast data packet(s), each of the UE 102A and 102B is assigned same UL radio resources (time/frequency) to transmit HARQ feedback in response to successfully receiving (or not successfully receiving) MBS data packet(s). Accordingly, when each of the UE 102A and 102B transmits 314, 316 the HARQ NACK to the base station on the same PUCCH, the base station 104 may not be able to identify which specific UE 102 (i.e., UE 102A or UE 102B) provided the HARQ NACK. Nevertheless, because the base station 104 is at least aware that at least one of the UE 102 (e.g., UE 102A or UE 102B) did not successfully receive the MBS data packet(s) at event 312, the base station 104 can later retransmit the MBS data packet(s) to the UE 102 (i.e., UE 102A and UE 102B).

The manner in which the UE 102 determines when to send the HARQ NACK on the PUCCH can vary. In some implementations, the base station 104 includes a timing indicator in the DCI command at event 310. From the timing indicator, the UE 102 can determine slot(s) or symbol(s) on which to transmit the HARQ NACK. In other implementations where the base station 104 does not include a timing indicator in the DCI command, the UE 102 can determine when to send the HARQ NACK on the PUCCH according to the PUCCH configuration(s) received at event 304. For example, each of the PUCCH configuration(s) can include time-domain configuration parameters configuring occurrences of PUCCH resources, or timing for a PDSCH (where a MBS data packet is transmitted) to an uplink HARQ NACK.

In response to receiving the HARQ NACK at events 314, 316 from the UE 102, the base station 104 can transmit 318 a DCI command and scrambled CRC to the UE 102, similar to event 310, and subsequently retransmit 320 MBS data packet(s) to the UE 102 on a PDSCH assigned by the DCI command in a HARQ retransmission pursuant to the HARQ process. The base station 104 can generate the HARQ retransmission of event 320 as having the same redundancy version (RV) or different RVs as the HARQ transmission of event 312.

If the UE 102 still does not successfully receive the MBS data packet(s) at event 320, the base station 104 can receive 322, 324 a HARQ NACK from the UE 102, similar to events 314, 316.

As described above, during the HARQ process, the base station 104 transmits a DCI command at event 310 prior to a HARQ transmission at event 312, and another DCI command at event 318 prior to a HARQ retransmission at event 320 if the UE 102 transmits a HARQ NACK at either of events 314, 316. To assist the UE 102 in determining whether the DCI command is for a HARQ transmission (i.e., a new HARQ transmission that has not been previously transmitted to the UE 102) or a HARQ retransmission, the base station 104 can include a new indicator (NDI) field in the DCI command to specify whether the DCI command is for a new HARQ transmission or a HARQ retransmission. Consequently, based on the NDI of the DCI command, the UE 102 can determine whether the HARQ transmission at events 312, 320 is a new HARQ transmission or a HARQ retransmission.

In some implementations, the base station 104 can set the NDI of a DCI command (e.g., the DCI command of event 310) to a first static default value (e.g., either a 0 or 1 as specified in a 3GPP specification) indicating that the HARQ transmission is a new HARQ transmission. Similarly, the base station 104 can set the NDI of a DCI command (e.g., the DCI command of event 318) to a second static default value (e.g., 1 if the first static default value is 0, 0 if the first static default value is 1, or the same value as the first static default value) indicating that the HARQ transmission is a HARQ retransmission of a previous HARQ transmission.

In other implementations, rather than using particular static NDI values to designate a HARQ transmission as a new HARQ transmission or a HARQ retransmission, the base station 104 can toggle (or not toggle) the NDI value to indicate whether the HARQ transmission is a new HARQ transmission or a HARQ retransmission. For example, the base station 104 can set the NDI of a DCI command (e.g., the DCI command of event 310) to an initial value (e.g., 0, 1) indicating that the HARQ transmission is a new HARQ transmission. Similarly, the base station 104 can set the NDI of a DCI command (e.g., the DCI command of event 318) to a toggled value (e.g., 1 if the initial value is 0, 0 if the initial value is 1) indicating that the HARQ transmission is a HARQ retransmission. Alternatively, the base station 104 can maintain the NDI of a DCI command (e.g., the DCI command of event 318) in its non-toggled state (e.g., 1 if the initial value is 1, 0 if the initial value is 0) indicating that the HARQ transmission is a HARQ retransmission. In this example, the base station 104 can toggle the NDI value to indicate additional new HARQ transmissions.

In some scenarios, if the base station 104 does not receive a HARQ NACK from the UE 102 at event 314, the base station 104 can transmit 318 a DCI command and a CRC scrambled with the G-RNTI K to the UE 102, similar to event 310, to transmit 320 new MBS data packet(s) in a new HARQ transmission, similar to event 312. In these scenarios, the base station 104 can set the NDI of the DCI command at event 318 to the first static default value described above, indicating that the HARQ transmission is a new HARQ transmission. In another implementation, the base station 104 can toggle the NDI value, relative to the NDI in the DCI command at event 310, to indicate that the HARQ transmission is a new transmission.

In response to receiving a DCI command and determining that the HARQ transmission is a new transmission according to the NDI included in the DCI command, the UE 102 can flush a soft buffer and store the HARQ transmission in the soft buffer. In response to determining that the HARQ transmission is a HARQ retransmission of a previous HARQ transmission according to the NDI included in the DCI command, the UE 102 can combine (i.e., HARQ combine) the HARQ transmission and the HARQ retransmission and decode the combined HARQ transmissions pursuant to the HARQ process.

Events 310, 312, 314, 316, 318, 320, 322 and 324 are collectively referred to as an MBS transmission procedure 350. In some implementations, the base station 104 can perform multiple MBS transmission procedures, each similar to MBS transmission procedure 350, in parallel or one after another by using different G-RNTIs. In some implementations, the base station 104 can perform multiple MBS transmission procedures for respective multiple MBSs (e.g., a first MBS, a second MBS, a third MBS, etc.) to transmit MBS data packets of the respective MBSs on respective PDSCHs using respective G-RNTIs on the cell 124. To schedule the respective PDSCHs on different frequency resources (e.g., physical resource blocks (PRBs)) and/or different time instances (e.g., slots or symbols), the base station 104 can transmit multiple DCI commands with CRCs scrambled by different G-RNTIs. For example, in addition to performing the MBS transmission procedure 350 using G-RNTI K to transmit MBS data packet(s) (e.g., of a first MBS), the base station 104 can perform a second MBS transmission procedure by transmitting second DCI command(s) and second CRC(s) scrambled with a second G-RNTI (e.g., G-RNTI L) on PDCCH(s) to schedule second PDSCH(s) including MBS data packet(s) (e.g., of a second MBS). Then the base station 104 can transmit the MBS data packet(s) in a HARQ transmission pursuant to the HARQ process on the second PDSCH(s). In other implementations, the base station 104 can perform multiple MBS transmission procedures for a single MBS to transmit MBS data packets of the single MBS on respective PDSCHs using respective G-RNTIs on the cell 124. To schedule the respective PDSCHs on different frequency resources (e.g., physical resource blocks (PRBs)) and/or different time instances (e.g., slots or symbols), the base station 104 can transmit multiple DCI commands with CRCs scrambled by different G-RNTIs. For example, in addition to performing the MBS transmission procedure 350 using G-RNTI K to transmit first MBS data packet(s) (e.g., of a first MBS), the base station 104 can perform a second MBS transmission procedure by transmitting second DCI command(s) and second CRC(s) scrambled with a second G-RNTI (e.g., G-RNTI L) on PDCCH(s) to schedule second PDSCH(s) including second MBS data packet(s) (e.g., of the first MBS). Then the base station 104 can transmit the second MBS data packet(s) in a HARQ transmission pursuant to the HARQ process on the second PDSCH(s). The UE 102 can process the first MBS data packet(s) and the second MBS data packet(s) jointly for the first MBS. For example, the first MBS data packet(s) can include voice packet(s) and the second MBS data packet(s) can include video packet(s). In another example, the first MBS data packet(s) can include packet(s) for basic video frame(s) and the second MBS data packet(s) can include packet(s) for enhancing the basic video frame(s) so that the UE 102 can use the first and second MBS data packet(s) to obtain high-resolution video frame(s).

In some implementations, the base station 104 may configure a particular G-RNTI not associated to a PUCCH configuration. In such implementations, the UE 102 receives PDSCH(s) including HARQ transmission(s) in accordance with the particular G-RNTI and does not transmit HARQ feedback for the HARQ transmission(s). The UE 102 receives HARQ transmission on PDSCHs in accordance with DCIs with CRCs scrambled with the particular G-RNTI. In some implementations, the base station 104 can set NDIs in the DCIs as described above by using automatic retransmission without HARQ feedback. In other implementations, the base station 104 does not transmit HARQ retransmissions. In this case, the base station 104 can set NDIs in the DCIs to the first default value or does not include an NDI in each of the DCIs.

Now referring to FIG. 3B, whereas the base station 104 of FIG. 3A multicasts or broadcasts G-RNTI K and PUCCH configuration(s) in the system information to the UE 102, the base station 104 of FIG. 3B transmits (i.e., unicasts) G-RNTI K and PUCCH configuration(s) in dedicated messages associated with a protocol for controlling radio resources (e.g., RRC messages) to the UE 102. Otherwise, any of the implementations described above in reference to FIG. 3A can be applied to scenario 300B of FIG. 3B.

Similar to scenario 300A, in scenario 300B, the UE 102 (i.e., UE 102A and UE 102B) initially operates in connected state (e.g., RRC_CONNECTED state), or more generally in a state in which there is an active radio connection between the UE 102 and the base station 104.

Base station 104 transmits 303 a first dedicated RRC message including the G-RNTI K to the UE 102A, and transmits 305 a second dedicated RRC message including the G-RNTI K to the UE 102B. Similarly, the base station 104 transmits 307 a third dedicated RRC message including the PUCCH configuration(s) to the UE 102A, and transmits 309 a fourth dedicated RRC message including the same PUCCH configuration(s) of event 307 to the UE 102B. In other implementations, the base station 104 can transmit the G-RNTI K and the PUCCH configuration(s) in the same dedicated RRC message (i.e., the first dedicated RRC message or the third dedicated RRC message) to the UE 102A. Similarly, the base station 104 can transmit the G-RNTI K and the PUCCH configuration(s) in the same dedicated RRC message (i.e., the second dedicated RRC message or the fourth dedicated RRC message) to the UE 102B. In some implementations, the base station 104 can include other G-RNTIs (e.g., G-RNTI L) in the first dedicated RRC message and the second dedicated RRC message. In yet other implementations, the base station 104 can transmit one or more RRC reconfiguration messages to the UE 102, to configure the other G-RNTIs. In some implementations, the base station 104 can configure the G-RNTIs (e.g., G-RNTI K, G-RNTI L) in response to a request or indication message from the UE 102, such as an UL RRC message (e.g., an MBS Interest Indication message), or in response to a request or indication message from the CN 110, such as a CN to BS interface message. The CN to BS interface message can be an NG application protocol message (e.g., a PDU Session Resource Setup Request message or PDU Session Resource Modify Request message).

In some implementations, each of the dedicated RRC messages described above can be a RRCSetup message, a RRCResume message, or a RRCReconfiguration message. The UE 102 can transmit a dedicated RRC response message in response to each of the dedicated RRC messages. The dedicated RRC response message can be a RRCSetupComplete message, a RRCResumeComplete message, or a RRCReconfiguration Complete message in response to the RRCSetup message, RRCResume message, or RRCReconfiguration message, respectively.

In some implementations, because the base station 104 transmits (i.e., unicasts) G-RNTI K and PUCCH configuration(s) in dedicated RRC messages to the UE 102, the base station 104 does not broadcast or multicast other G-RNTI(s) and other PUCCH configuration(s). In other implementations, the base station 104 still broadcasts or multicasts other G-RNTI(s) and other PUCCH configuration(s) to the UE 102, to enable the UE 102 to transmit HARQ NACK(s) for HARQ transmission(s) on PDSCH(s) scheduled by the other G-RNTI(s), as described in FIG. 3A.

In some implementations, in addition to transmitting a PUCCH configuration to the UE 102 for MBS communication using the G-RNTI K of the UE 102, the base station 104 can transmit to the UE 102 a second PUCCH configuration (e.g., PUCCH-Config IE or PUCCH-ConfigCommon IE) to the UE 102 for transmitting HARQ feedback to unicast communication during a HARQ process using a unique C-RNTI known by each respective UE 102 (i.e., UE 102A and UE 102B). Although the C-RNTI known by the UE 102A is different than the C-RNTI known by the UE 102B, the second PUCCH configuration transmitted to the UE 102A can be the same (or different from) the second PUCCH configuration transmitted to the UE 102B.

The base station 104 can perform a HARQ process for unicast communication similar to the manner in which the base station 104 performs a HARQ process for MBS communication. For instance, base station 104 generates a DCI command which assigns a PDSCH, so that the base station 104 can transmit unicast data packet(s) to the UE 102 on the PDSCH. The base station 104 generates a CRC for the DCI command and scrambles the CRC with a C-RNTI to obtain a scrambled CRC. The base station 104 can transmit the DCI command and the CRC scrambled with the C-RNTI to the UE 102 on a PDCCH. The UE 102 de-scrambles the received scrambled CRC using the C-RNTI known by the UE 102, so that the UE 102 can recognize (and be aware of) the PDSCH assigned by the DCI command on which the base station 104 will transmit unicast data packet(s). After transmitting the DCI command and the scrambled CRC, the base station 104 transmits the unicast data packet(s) in a HARQ transmission pursuant to the HARQ process on the PDSCH. If the UE 102 successfully receives the HARQ transmission, the UE 102 transmits a HARQ ACK on a PUCCH to the base station 104 in accordance with the second PUCCH configuration. Otherwise, the UE 102 transmits a HARQ NACK on the PUCCH.

The base station 104 can transmit the second PUCCH configuration to the UE 102 in various manners. In some implementations, the base station 104 can broadcast a SIB1 including the second PUCCH configuration on the cell 124. In other implementations, the base station 104 can include the second PUCCH configuration in one of more of the dedicated RRC message described above. For instance, the base station 104 can send an RRC reconfiguration message (e.g., RRCReconfiguration message) including the second PUCCH configuration to the UE 102. The UE 102 can transmit an RRC reconfiguration complete message (e.g., RRCReconfiguration Complete message) to the base station 104 in response to the RRC reconfiguration message.

In some implementations, the second PUCCH configuration for the unicast HARQ process can include one or more PUCCH resources that are the same as those included in the PUCCH configuration for the MBS HARQ process. In other implementations, none of the PUCCH resources included in the PUCCH configuration and the second PUCCH configuration are the same. In some implementations, the UE 102 is capable of a fixed number of HARQ processes (e.g., Z HARQ processes, e.g., Z=8, 16 or 32) for receiving both unicast and multicast/broadcast transmissions (i.e., HARQ transmissions). In some implementations, the base station 104 can configure the number of HARQ processes (e.g., X HARQ processes, X<2, 3, 4 . . . or Z) that the UE 102 can use for receiving either unicast transmission or multicast/broadcast transmissions. Thus, the UE 102 refrains from using more than the configured number of HARQ processes to receive multicast/broadcast transmissions. In other implementations, the base station 104 does not configure the number of HARQ processes. Instead, the base station 104 derives the number of HARQ processes that the UE 102 is using to receive multicast/broadcast transmissions in accordance with the number of G-RNTIs (e.g., Y G-RNTIs, Y<7) that the base station 104 configures to the UE 102, or information corresponding to/associated to the G-RNTIs. Therefore, the base station 104 derives that a remaining number of HARQ processes (e.g., Z-Y) that the UE 102 can use to receive unicast transmissions, in accordance with the number of HARQ processes for receiving multicast/broadcast transmissions. The base station 104 refrains from configuring the UE 102 to receive unicast transmissions using more than the remaining number of HARQ processes.

In other implementations, a pre-defined maximum number of HARQ processes for multicast/broadcast transmissions are specified in a 3GPP specification. The base station 104 refrains from configuring the UE 102 to receive multicast/broadcast transmissions using more than the pre-defined maximum number. The UE 102 also does not use more than the pre-defended maximum number of HARQ processes to receive multicast/broadcast transmissions. The UE 102 is capable of a fixed number of HARQ processes (e.g., Z HARQ processes, e.g., Z=8, 16 or 32) for receiving both unicast and multicast/broadcast transmissions (i.e., HARQ transmissions) or unicast transmissions only.

In yet other implementations, the UE 102 can send a UE capability indicating a maximum number of HARQ processes for multicast/broadcast transmissions to the base station 104, e.g., in a UE Capability Information message. Alternatively, the base station 104 can receive the UE capability from another base station (e.g., base station 106A, 106B) or the CN 110. The base station 104 refrains from configuring the UE 102 to receive multicast/broadcast transmissions using more than the pre-defined maximum number. The UE 102 also does not use more than the pre-defended maximum number of HARQ processes to receive multicast/broadcast transmissions.

In some implementations, the base station 104 can configure the UE 102 to send a HARQ ACK or not. For example, the base station 104 can enable or disable the UE 102 to transmit a HARQ ACK for indicating successful reception of a HARQ transmission including MBS data packet(s), by including a field or IE in the dedicated RRC message 303, 305, 307, 309 or in the second PUCCH configuration(s) 307, 309. Alternatively, if the base station 104 does not include the field or IE to disable transmitting a HARQ ACK in the dedicated RRC message, the UE 102 can transmit a HARQ ACK for the HARQ transmission. Yet alternatively, if the base station 104 does not include the field or IE to enable transmitting a HARQ ACK in the dedicated RRC message, the UE 102 refrains from transmitting a HARQ ACK for the HARQ transmission.

Turning to the methods of this disclosure, FIG. 4 and FIG. 5 illustrate general methods that a UE and a base station, respectively, can use for constructing and interpreting a type-2 HARQ codebook in multi-MBS scenarios. Before describing these figures, the techniques of this disclosure are introduced by way of an example, described below with reference to Table 1.

Table 1 illustrates a set of PDCCH monitoring occasions corresponding to an example MBS data transmission scenario in a single cell. Initially, a base station configures a UE with a G-RNTI 1 and a G-RNTI 2 for receiving a first MBS and a second MBS in a cell, respectively (e.g., event 302) (where this cell is labeled with CC #0). Further, the base station also configures the UE to report HARQ feedback using a type-2 HARQ codebook. In Table 1, different monitoring occasions on the PDCCH are labeled by the index “m.” At the first PDCCH monitoring occasion (m=0), the base station transmits (e.g., broadcasts or multicasts), a first DCI (DCI 1) with a CRC scrambled using G-RNTI 1. DCI 1 schedules a downlink transmission of transport block TB_1, where a transport block includes MBS data. DCI 1 also includes a counter downlink assignment index (C-DAI) field (also referred to herein as V_{C-DAI}), having a value equal to 1, indexing DCI 1. Likewise, the base station also transmits, at monitoring occasions m=1 through m=4, DCIs 2, 3, 4, and 5, respectively, where each of DCIs 2-5 includes a CRC scrambled using G-RNTI 1. DCIs 2-5 schedule transport blocks TB_2, TB_3, TB_4, and TB_5, respectively. Further, the DCIs 2-5 include C-DAI values V_{C-DAI}=2, V_{C-DAI}=3, V_{C-DAI}=4, and V_{C-DAI}=1, indexing DCIs 2-5, respectively. DCIs 1-5 schedule data transmissions for the first MBS.

Continuing with Table 1, the base station also transmits, at monitoring occasions m=1 and m=3, respectively, DCIs 6 and 7 scheduling data transmissions for the second MBS. The base station transmits each of DCIs 6 and 7 with a CRC scrambled using G-RNTI 2. DCIs 6 and 7 schedule downlink transmissions of transport blocks TB_a and TB_b, respectively. DCIs 6 and 7 also each include C-DAI values V_{C-DAI}=1 and V_{C-DAI}=2, indexing DCIs 6 and 7, respectively. G-RNTIs 1 and 2 each are associated with a different C-DAI counter, such that the first DCIs transmitted for each MBS (i.e., DCI 1 and DCI 6), each start with 1, the initial value of the C-DAI field.

For each DCI, the V_{C-DAI} field includes two bits and can be calculated based on Table 2, where the parameter T_{D}=2^{N}=4 for N=2 (where N corresponds to the number of bits of the field). Table 2 corresponds to Table 9.1.3-1, entitled “Value of counter DAI for N_{C-DAI}^{DL}=2 and total DAI,” from 3GPP TS 38.213. The parameter Y in the equation listed in Table 2 is equal to the index of the DCI, were the index capable of being represented as a base-10 number. For example, Y=1-5 for DCIs 1-5, respectively, Y=1 for DCI 6, and Y=2 for DCI 7 (because G-RNTIs 1 and 2 have separate C-DAI counters).

TABLE 1
Multiple MBS data transmission and DAI indication

| PDCCH | | | | | | |
|---|---|---|---|---|---|---|
| occasion | | | | | | |
| index | m = 0 | m = 1 | m = 2 | m = 3 | m = 4 | m = 5 |
| CC #0 | G-RNTI 1 | G-RNTI 1 | G-RNTI 1 | G-RNTI 1 | G-RNTI 1 | C-RNTI |
| | DCI 1 | DCI 2 | DCI 3 | DCI 4 | DCI 5 | DCI 8 |
| | TB_1 | TB_2 | TB_3 | TB_4 | TB_5 | V_{T-DAI} = 3 |
| | V_{C-DAI} = 1 | V_{C-DAI} = 2 | V_{C-DAI} = 3 | V_{C-DAI} = 4 | V_{C-DAI} = 1 | |
| | | G-RNTI 2 | | G-RNTI 2 | | |
| | | DCI 6 | | DCI 7 | | |
| | | TB_a | | TB_b | | |
| | | V_{C-DAI} = 1 | | V_{C-DAI} = 2 | | |

TABLE 2
Table of DL counter DAI (V_{C-DAI}^{DL}) and total DAI (V_{T-DAI}^{DL})

| | | Number of {serving cell, PDCCH monitoring occasion}- |
|---|---|---|
| | | pair(s) in which PDSCH transmission(s) associated |
| | | with PDCCH or PDCCH generating a HARQ-ACK |
| | | information bit without scheduling a PDSCH reception |
| DAI | | or providing TCI state update is present, denoted as Y |
| MSB, LSB | V_{C-DAI}^{DL} Or V_{T-DAI}^{DL} | and Y ≥ 1 |
| 0, 0 | 1 | (Y − 1)mod T_{D} + 1 = 1 |
| 0, 1 | 2 | (Y − 1)mod T_{D} + 1 = 2 |
| 1, 0 | 3 | (Y − 1)mod T_{D} + 1 = 3 |
| 1, 1 | 4 | (Y − 1)mod T_{D} + 1 = 4 |

TABLE 3
Table of UL total DAI (T-DAI)

| | | Number of {serving cell, PDCCH monitoring occasion}- |
|---|---|---|
| | | pair(s) in which PDSCH transmission(s) associated |
| | | with PDCCH or PDCCH indicating SPS PDSCH |
| | | release or providing TCI state update or DCI format |
| DAI | | 1_1 indicating SCell dormancy is present, denoted as X |
| MSB, LSB | V_{T-DAI}^{UL} | and X ≥ 1 |
| 0, 0 | 1 | (X − 1)mod T_{D} + 1 = 1 |
| 0, 1 | 2 | (X − 1)mod T_{D} + 1 = 2 |
| 1, 0 | 3 | (X − 1)mod T_{D} + 1 = 3 |
| 1, 1 | 4 | (X − 1)mod T_{D} + 1 = 4 |

For DCIs 1-7, the base station assigns, to the UE, the same PUCCH resource and the same HARQ feedback timing. In response to receiving the same PUCCH resource and HARQ feedback timing, the UE generates and multiplexes HARQ feedbacks of data transmissions scheduled by these DCIs in a type-2 HARQ codebook. Because the DCIs 1-7 correspond to two MBSs, the type-2 HARQ codebook includes two sub-codebooks: a first sub-codebook including HARQ feedback associated with G-RNTI 1 (i.e., the first MBS), and a second sub-codebook including HARQ feedback associated with G-RNTI 2 (i.e., the second MBS). To construct the type-2 HARQ codebook, the UE can concatenate the first and second sub-codebooks in an order based on the G-RNTI values (e.g., the type-2 HARQ codebook can include the first sub-codebook, followed by the second sub-codebook). Further, instead of transmitting the type-2 HARQ codebook at the scheduled PUCCH occasion, the UE transmits the type-2 HARQ codebook at a PUSCH occasion, scheduled by the base station.

The base station schedules the UE to multiplex the HARQ codebook and transmit the multiplexed HARQ codebook at a PUSCH occasion by sending the UE an uplink grant (e.g., uplink grant DCI format, such as DCI format 0_1). Referring to Table 1, the base station transmits an uplink grant, DCI 8, at a PDCCH monitoring occasion (m=5 in Table 1). The DCI 8 includes an uplink DAI (UL-DAI) having a value V_{T-DAI}=3. The value V_{T-DAI} of the UL-DAI can be calculated using Table 3 by setting X equal to the sum of the largest DAI index of G-RNTI 1 and the largest DAI index of G-RNTI 2 (i.e., to the total number of DCIs for the G-RNTI 1 and the G-RNTI 2 combined). Accordingly, X=5+2=7, and, using Table 3. V_{T-DAI}=3. Table 3 corresponds to Table 9.1.3-2, entitled “Value of DAI,” from 3GPP TS 38.213.

A UE can utilize the techniques of this disclosure to construct a type-2 HARQ codebook. In an example scenario, the UE misses or fails to decode the DCIs 4 and 5 shown in Table 1. The UE generates two sub-codebooks, a first sub-codebook for the first MBS, and a second sub-codebook for the second MBS. To generate the first sub-codebook, the UE adds the index (i.e., the C-DAI) of the last received DCI of G-RNTI 1 (i.e., DCI 3 with V_{C-DAI}=3) in the beginning of the first sub-codebook. Based on Table 2, V_{C-DAI}=3 maps to the two-bit index {1, 0}. The UE then appends the HARQ feedbacks (i.e., ACK (A) or NACK (N)) for the TB_1, TB_2, and TB_3 corresponding to received DCIs 1-3 in the first sub-codebook. Thus, the first sub-codebook can be written as {1, 0, A/N, A/N, A/N}. Similarly, to generate the second sub-codebook, the UE adds the index of the last received DCI of G-RNTI 2 (i.e., DCI 7, having V_{C-DAI}=2). Based on Table 2, V_{C-DAI}=2 maps to the two-bit index {0, 1}. The UE also appends the HARQ feedbacks (i.e., A or N) for the TB_a and TB_b, corresponding to received DCIs 6 and 7. The second sub-codebook can therefore be written as {0, 1. A/N. A/N}.

In addition to the first and second sub-codebooks, the UE includes, in the codebook. NACKs corresponding to the two missing DCIs. To determine the number of missing DCIs, the UE first derives the total number of transmitted DCIs using the T-DAI value V_{T-DAI}=3 included in DCI 8 (i.e., the UL-DAI). Using Table 3, the UE determines a smallest X that maps to a T-DAI value V_{T-DAI}=3 (i.e., from X=3, 7, 11 . . . ), that is larger than or equal to the total number of DCIs associated with the HARQ codebook (i.e., 5, because the UE successfully received 5 DCIs, DCIs 1-3, DCI 6, and DCI 7). In this scenario, the smallest X that fits these criteria is 7. By subtracting the total number of DCIs received by the UE (5), from the total number of transmitted DCIs (X=7), the UE can determine that there are two missing DCIs. To complete the codebook, the UE concatenates the first sub-codebook followed by the second sub-codebook. To align the HARQ codebook size with the codebook size expected by the base station, the UE appends two NACKs (corresponding to the two missing DCIs), after the second sub-codebook (i.e., after the last sub-codebook indicating HARQ feedback for the MBS). The final type-2 HARQ codebook for this example scenario can then be written as {{first sub-codebook}, {second sub-codebook}, appended NACKs}={{1, 0, A/N, A/N, A/N}, {0, 1, A/N, A/N}, N, N}.

After the base station receives the type-2 HARQ codebook from the UE, the base station parses the first sub-codebook by reading the first two bits (i.e., {1, 0}} from the beginning of the HARQ codebook. The base station can utilize Table 2 to find a largest Y that maps to {1, 0} (i.e., 3, 7, 11, . . . ), that is smaller than or equal to the number of total transmitted DCIs for the first MBS (i.e., 5, corresponding to DCIs 1-5). The Y that fits this criteria in the example scenario is Y=3. Accordingly, the base station can determine that the last DCI that the UE received was the third DCI, DCI 3. The base station also identifies the number of ACK/NACKs in the first sub-codebook, i.e., three. The base station can then determine that the UE failed to receive DCIs 4 and 5, because the largest downlink assignment index (i.e., in base-10) of the first MBS was 5. Similarly, the base station also parses the second sub-codebook by reading the first two bits (i.e., {0, 1}), and determines that the number of ACK/NACKs included in the second sub-codebook is two. The base station can therefore determine that the UE received each of the two DCIs transmitted for the second MBS. After the base station has parsed all of the HARQ feedbacks included in the HARQ codebook, the base station can retransmit, to the UE, DCIs 4 and 5, as well as any DCIs associated with a NACK in the HARQ codebook.

Depending on the implementation, the bit width of the UL-DAI can be the same or different to the bit-width of the downlink assignment C-DAI. For example, the bit width (e.g., N bits) of the UL-DAI, as configured by RRC signaling or as specified in existing or future 3GPP standards, can be a different value from the bit width in the example scenario discussed above (i.e., 2 bits). In such cases, the parameter T_{D} can be updated by setting T_{D}=2^{N} in Table 2. For example, if N=3, T_{D}=8, and UL-DAI value 1 maps to {0, 0, 0}, 2 maps to {0, 0, 1}, . . . , and 8 maps to {1, 1, 1}, etc.

The brackets of the HARQ codebook examples included above are used to clarify the HARQ codebook structure, and may not be included in the actual implementation.

If the base station also transmits unicast transmissions to the UE, and the unicast transmissions are also associated with the HARQ codebook, the UE can generate a sub-codebook for the unicast transmissions, and place the unicast sub-codebook in the HARQ codebook (e.g., in front of the sub-codebooks for the multicast transmissions). If the base station also configures features such as code block group (CBG), semi-persistent scheduling (SPS), and/or group common semi-persistent scheduling, and indicates to the UE to report HARQ feedback in the same HARQ codebook as sub-codebooks for multicast transmissions, the UE can place corresponding HARQ feedbacks in front of or behind the sub-codebooks for the multicast transmissions.

Referring to FIG. 4, a UE (e.g., the UE 102) can implement a method 400 for reporting feedback for a multicast and/or broadcast service (MBS) when the UE is receiving multiple MBSs. At block 402, the UE receives, during a certain time period when a base station generates a sequence of downlink assignments for the multiple MBSs, at least some of these downlink assignments. Each downlink assignment schedules a respective data transmission of the corresponding MBS and can be a DCI, for example (as a more specific example, DCI format 1_1). The base station may generate the sequence of downlink assignments (e.g., DCIs) scheduling data transmissions for the multiple MBSs (e.g., DCIs 1-7 in the Table 1 example, where DCIs 1-5 schedule data transmissions for a first MBS, and DCIs 6-7 schedule data transmissions for a second MBS), and transmit the downlink assignments over a range of occasions on a control channel (e.g., PDCCH) (e.g., occasions m=0-4 in the Table 1 example). The time period may refer to a time window over which the base station generates a sequence of DCIs for transmission over the range of control channel occasions.

Within the sequence of downlink assignments, there may be downlink assignments for each of the multiple MBSs. For example, the plurality of downlink assignments, that the UE receives, may be either DCIs 1-5 (or DCIs 1-3 if the UE does not receive DCIs 4 and 5) scheduling data transmissions for the first MBS, or DCIs 6-7 scheduling data transmissions for the second MBS. To identify a downlink assignment as corresponding to a particular MBS, the base station can transmit, with each downlink assignment, a CRC scrambled using a G-RNTI for the particular MBS (e.g., transmit a CRC scrambled with G-RNTI 1 with DCIs 1-5, and a CRC scrambled with G-RNTI 2 with DCIs 6-7). The UE can unscramble the CRC with the corresponding G-RNTI. Further, the base station need not transmit a DCI for each of the multiple MBSs at each control channel occasion (e.g., at m=0, 2, and 4, the base station transmits DCI 1 scheduling a data transmission for the first MBS, but does not transmit a DCI scheduling a data transmission for the second MBS). In addition, each of the sequence of downlink assignments can include a value of a counter (e.g., value of C-DAI). More particularly, there may be a different, independent counter for each MBS of the multiple MBSs.

At a control channel occasion (e.g., m=5), the base station can transmit an uplink grant (e.g., an UL DCI with format 0_1, such as DCI 8) scheduling uplink resources on which the UE can transmit uplink feedback for the sequence of downlink assignments. The base station can transmit the uplink grant with a CRC scrambled using a temporary identifier dedicated to the UE (e.g., a C-RNTI), and the UE can descramble the CRC using the temporary identifier, such that the UE can identify that the uplink grant is specific for the UE. The UE can multiplex feedback related to the data scheduled by sequence of downlink assignments and transmit the multiplexed feedback (e.g., in a type-2 HARQ codebook) in accordance with the uplink grant. The uplink grant may indicate or include a number of total data transmissions that the base station scheduled using the sequence of downlink assignments, i.e., scheduled during the time period (e.g., a sum of the total number of data transmissions of the multiple MBSs, 7 in the example of Table 1). The number of total data transmissions may be represented using two bits (e.g., T-DAI value V_{T-DAI}=3, which can be represented as {1, 0}, where the total number of data transmissions is 7). Further, the number of total data transmissions may be referred to as a UL-DAI.

At block 404, the UE attempts to receive, from the base station, the plurality of data transmissions in accordance with the plurality of downlink assignments. In the example data transmission scenario of Table 1, the UE attempts to receive TB_1, TB_2, TB_3, TB_4, and TB_5 (provided the UE receives DCIs 1-5). If the UE does not receive DCIs 4 and 5, then the UE attempts to receive only TB_1, TB_2, and TB_3.

At block 406, the UE transmits, to the base station, feedback for the plurality of data transmissions, the feedback including an indication of a last successfully received downlink assignment of the plurality of downlink assignments. The UE can transmit the feedback in accordance with an uplink grant that the UE receives (described above with respect to block 402). The feedback may be a type-2 HARQ codebook including a sub-codebook for the MBS. The type-2 HARQ codebook may include a sub-codebook for each of the multiple MBSs for which the UE receives downlink assignments. The indication may correspond to a C-DAI included in the last successfully received DCI, and the UE may include the indication in the feedback as two bits (e.g., {1,0}, the two-bit representation of V_{C-DAI}=3, in the example where the UE receives DCIs 1-3 but not DCIs 4-5). More particularly, if the feedback is a HARQ codebook, the UE can include in the indication (e.g., {1,0}) at the beginning of the sub-codebook for the MBS. In the sub-codebook for the MBS, the UE can also include, after the indication of the last successfully received downlink assignment, ACKs/NACKs for the data transmissions for which the UE successfully received the corresponding downlink assignments (e.g., {A/N for TB_1, A/N for TB_2, A/N for TB_3}).

In the feedback, the UE can also include an indication of the number of data transmissions (scheduled by the sequence of downlink assignments) that the UE did not successfully receive. The UE can determine the total number of data transmissions for the multiple MBSs (i.e., all of the data transmissions scheduled by the sequence of downlink assignments, 7 in the Table 1 example) based on the UL-DAI included in the uplink grant, and can determine the total number of data transmissions of the multiple MBSs that were successfully received (e.g., 5 in the Table 1 example where the UE does not receive DCIs 4-5). By subtracting the total number of data transmissions that were successfully received from the total number of data transmissions, the UE can determine the number of data transmissions that the UE did not successfully received. The UE can append NACKs for each of these unsuccessfully received data transmissions in the HARQ codebook after the sub-codebooks for the multiple MBSs, for example.

Referring to FIG. 5, a base station (e.g., the base station 104 or 106) can implement a method 500 for receiving feedback for a multicast and/or broadcast service (MBS) when the base station is transmitting multiple MBSs. FIG. 5 is similar to FIG. 4, except that FIG. 5 includes actions performed by the base station rather than the UE. Accordingly, the description above for FIG. 4 also applies to FIG. 5. At block 502, the base station transmits, to the UE, during a time period when the base station generates a sequence of downlink assignments for the multiple MBSs, a plurality of downlink assignments included in the sequence of the downlink assignments, the plurality of downlink assignments scheduling a respective plurality of data transmissions of the MBS. At block 504, the base station transmits, to the UE, the plurality of data transmissions in accordance with the plurality of downlink assignments. At block 506, the base station receives, from the UE, feedback for the plurality of data transmissions, the feedback including an indication of a last successfully received downlink assignment of the plurality of downlink assignments.

The disclosure contemplates at least the following examples:

Example 1. A method in a user equipment (UE) for reporting feedback for a multicast and/or broadcast service (MBS) when the UE is receiving multiple MBSs, the method comprising: receiving, by processing hardware of the UE, during a time period when a base station generates a sequence of downlink assignments for the multiple MBSs, a plurality of downlink assignments included in the sequence of the downlink assignments, the plurality of downlink assignments scheduling a respective plurality of data transmissions of the MBS; attempting, by the processing hardware, to receive, from the base station, the plurality of data transmissions in accordance with the plurality of downlink assignments; and transmitting, by the processing hardware to the base station, feedback for the plurality of data transmissions, the feedback including an indication of a last successfully received downlink assignment of the plurality of downlink assignments.

Example 2. The method of example 1, wherein receiving the plurality of downlink assignments includes: receiving, in each downlink assignment of the plurality of downlink assignments, a value of a counter, wherein the last successfully received downlink assignment includes a first value of the counter; and transmitting the feedback includes: transmitting the feedback including the indication, the indication corresponding to first value.

Example 3. The method of example 2, wherein the counter is a counter downlink assignment index (C-DAI).

Example 4. The method of example 2 or 3, wherein transmitting the feedback includes: including the indication as two bits corresponding to the first value.

Example 5. The method of any one of the preceding examples, further comprising: receiving, by the processing hardware from the base station, an uplink grant scheduling uplink feedback; wherein transmitting the feedback includes transmitting the feedback in accordance with the uplink grant.

Example 6. The method of example 5, wherein receiving the uplink grant includes receiving the uplink grant including a sum of a total number of data transmissions of the multiple MBSs scheduled during the time period.

Example 7. The method of example 6, wherein the sum is an uplink downlink assignment index (UL-DAI).

Example 8. The method of example 6 or 7, wherein the sum is a first sum, the method further comprising: determining, by the processing hardware, based on (i) the first sum and (ii) a second sum of a total number of successfully received data transmissions of the multiple MBSs, a number of data transmissions not successfully received; and including, by the processing hardware, in the feedback, an indication of the number of data transmissions not successfully received.

Example 9. The method of any one of examples 6-8, wherein receiving the uplink grant includes: receiving a scrambled cyclic redundancy check (CRC) with the uplink grant; and unscrambling the CRC using a temporary identifier dedicated to the UE.

Example 10. The method of example 9, wherein the temporary identifier dedicated to the UE is cell radio network temporary identifier (C-RNTI).

Example 11. The method of any one of the preceding examples, wherein receiving the plurality of downlink assignments includes: unscrambling a plurality of cyclic redundancy checks (CRCs) received with the respective plurality of downlink assignments using a temporary identifier associated with the MBS.

Example 12. The method of example 11, wherein the temporary identifier associated with the MBS is a group radio network temporary identifier (G-RNTI) or group configured scheduling RNTI (G-CS-RNTI).

Example 13. The method of any one of the preceding examples, wherein transmitting the feedback includes: transmitting a hybrid automatic repeat request (HARQ) codebook including a sub-codebook for the MBS, the sub-codebook including the indication.

Example 14. The method of example 13, wherein transmitting the HARQ codebook includes: transmitting a type-2 HARQ codebook.

Example 15. The method of example 13 or 14, wherein transmitting the HARQ codebook includes: including the indication at the beginning of the sub-codebook for the MBS.

Example 16. The method of any one of the preceding examples, wherein receiving the plurality of downlink assignments includes: receiving a plurality of downlink control information (DCI) transmissions.

Example 17. A user equipment (UE) including processing hardware and configured to implement a method according to any one of the preceding examples.

Example 18. A method in a base station for receiving feedback for a multicast and/or broadcast service (MBS) when the base station is transmitting multiple MBSs, the method comprising: transmitting, by processing hardware of the base station to the UE, during a time period when the base station generates a sequence of downlink assignments for the multiple MBSs, a plurality of downlink assignments included in the sequence of the downlink assignments, the plurality of downlink assignments scheduling a respective plurality of data transmissions of the MBS; transmitting, by the processing hardware to the UE, the plurality of data transmissions in accordance with the plurality of downlink assignments; and receiving, by the processing hardware from the UE, feedback for the plurality of data transmissions, the feedback including an indication of a last successfully received downlink assignment of the plurality of downlink assignments.

Example 19. The method of example 18, wherein: transmitting the plurality of downlink assignments includes: transmitting, in each downlink assignment of the plurality of downlink assignments, a value of a counter; and receiving the feedback includes: determining, based on the indication, a first value of the counter; and determining, based on the first value, which downlink assignment of the plurality of downlink assignments was last successfully received.

Example 20. The method of example 19, wherein the counter is a counter downlink assignment index (C-DAI).

Example 21. The method of example 19 or 20, wherein receiving the feedback includes receiving the indication as two bits corresponding to the first value.

Example 22. The method of any one of examples 18-21, further comprising: transmitting, by the processing hardware to the UE, an uplink grant scheduling uplink feedback; wherein receiving the feedback includes receiving the feedback in accordance with the uplink grant.

Example 23. The method of example 22, wherein transmitting the uplink grant includes transmitting the uplink grant including a sum of a total number of data transmissions of the multiple MBSs scheduled during the time period.

Example 24. The method of example 23, wherein the sum is an uplink downlink assignment index (UL-DAI).

Example 25. The method of any one of examples 22-24, wherein transmitting the uplink grant includes: scrambling a cyclic redundancy check (CRC) using a temporary identifier dedicated to the UE; and transmitting the CRC with the uplink grant.

Example 26. The method of example 25, wherein the temporary identifier dedicated to the UE is cell radio network temporary identifier (C-RNTI).

Example 27. The method of any one of examples 18-26, wherein receiving the feedback includes: receiving, in the feedback, an indication of a total number of data transmissions of the multiple MBSs not successfully received by the UE.

Example 28. The method of any one of examples 18-27, wherein transmitting the plurality of downlink assignments includes: transmitting, with each of the plurality of downlink assignments, a cyclic redundancy check (CRC) scrambled using a temporary identifier associated with the MBS.

Example 29. The method of example 28, wherein the temporary identifier associated with the MBS is a group radio network temporary identifier (G-RNTI).

Example 30. The method of any one of examples 18-29, wherein transmitting the feedback includes transmitting a hybrid automatic repeat request (HARQ) codebook including a sub-codebook for the MBS, the sub-codebook including the indication.

Example 31. The method of example 30, wherein receiving the HARQ codebook includes: receiving a type-2 HARQ codebook.

Example 32. The method of example 30 or 31, wherein receiving the HARQ codebook includes: receiving the HARQ codebook including the indication at the beginning of the sub-codebook for the MBS.

Example 33. The method of any one of examples 18-32, wherein transmitting the plurality of downlink assignments includes: transmitting a plurality of downlink control information (DCI) transmissions.

Example 34. A base station including processing hardware and configured to implement a method according to any one of examples 18-33.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for managing HARQ transmissions through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a user equipment (UE) for reporting feedback for a multicast and/or broadcast service (MBS) when the UE is receiving multiple MBSs, the method comprising:
receiving, by the UE, during a time period when a base station generates a sequence of downlink assignments for the multiple MBSs, a plurality of downlink assignments included in the sequence of the downlink assignments, the plurality of downlink assignments scheduling a respective plurality of data transmissions of the MBS;
attempting to receive, from the base station, the plurality of data transmissions in accordance with the plurality of downlink assignments; and
transmitting, to the base station, feedback for the plurality of data transmissions, the feedback including an indication of a last successfully received downlink assignment of the plurality of downlink assignments.

2. The method of claim 1, wherein:
receiving the plurality of downlink assignments includes:
receiving, in each downlink assignment of the plurality of downlink assignments, a value of a counter downlink assignment index (C-DAI), wherein the last successfully received downlink assignment includes a first value of the C-DAI; and
transmitting the feedback includes:
transmitting the feedback including the indication, the indication corresponding to first value.

3. The method of claim 1, further comprising:
receiving, from the base station, an uplink grant scheduling uplink feedback;
wherein transmitting the feedback includes transmitting the feedback in accordance with the uplink grant.

4. The method of claim 3, wherein receiving the uplink grant includes:
receiving the uplink grant including an uplink downlink assignment index (UL-DAI) corresponding to a sum of a total number of data transmissions of the multiple MBSs scheduled during the time period.

5. The method of claim 4, wherein the sum is a first sum, the method further comprising:
determining based on (i) the first sum and (ii) a second sum of a total number of successfully received data transmissions of the multiple MBSs, a number of data transmissions not successfully received; and
including in the feedback, an indication of the number of data transmissions not successfully received.

6. The method of claim 1, wherein receiving the plurality of downlink assignments includes:
unscrambling a plurality of cyclic redundancy checks (CRCs) received with the respective plurality of downlink assignments using a temporary identifier associated with the MBS.

7. The method of claim 1, wherein transmitting the feedback includes:
transmitting a hybrid automatic repeat request (HARQ) codebook including a sub-codebook for the MBS, the sub-codebook including the indication.

8. The method of claim 7, wherein transmitting the HARQ codebook includes:
transmitting a type-2 HARQ codebook.

9. A user equipment (UE) including processing hardware and configured to report feedback for a multicast and/or broadcast service (MBS) when the UE is receiving multiple MBSs, including:
receive, during a time period when a base station generates a sequence of downlink assignments for the multiple MBSs, a plurality of downlink assignments included in the sequence of the downlink assignments, the plurality of downlink assignments scheduling a respective plurality of data transmissions of the MBS,
attempt to receive, from the base station, the plurality of data transmissions in accordance with the plurality of downlink assignments, and
transmit, to the base station, feedback for the plurality of data transmissions, the feedback including an indication of a last successfully received downlink assignment of the plurality of downlink assignments.

10. A method in a base station for receiving feedback for a multicast and/or broadcast service (MBS) when the base station is transmitting multiple MBSs, the method comprising:
transmitting, by the base station to the UE, during a time period when the base station generates a sequence of downlink assignments for the multiple MBSs, a plurality of downlink assignments included in the sequence of the downlink assignments, the plurality of downlink assignments scheduling a respective plurality of data transmissions of the MBS;
transmitting, to the UE, the plurality of data transmissions in accordance with the plurality of downlink assignments; and
receiving, from the UE, feedback for the plurality of data transmissions, the feedback including an indication of a last successfully received downlink assignment of the plurality of downlink assignments.

11. The method of claim 10, wherein:
transmitting the plurality of downlink assignments includes:
transmitting, in each downlink assignment of the plurality of downlink assignments, a value of a counter; and
receiving the feedback includes:
determining, based on the indication, a first value of the counter; and
determining, based on the first value, which downlink assignment of the plurality of downlink assignments was last successfully received.

12. The method of claim 11, wherein the counter is a counter downlink assignment index (C-DAI).

13. The method of claim 10, further comprising:
transmitting, to the UE, an uplink grant scheduling uplink feedback;
wherein receiving the feedback includes receiving the feedback in accordance with the uplink grant.

14. The method of claim 13, wherein transmitting the uplink grant includes:
transmitting the uplink grant including an uplink downlink assignment index (UL-DAI) corresponding to a sum of a total number of data transmissions of the multiple MBSs scheduled during the time period.

15. (canceled)

16. The UE of claim 9, wherein to receive the plurality of downlink assignments, the UE is configured to:
receive, in each downlink assignment of the plurality of downlink assignments, a value of a counter downlink assignment index (C-DAI), wherein the last successfully received downlink assignment includes a first value of the C-DAI; and
to transmit the feedback, the UE is configured to:
transmit the feedback including the indication, the indication corresponding to first value.

17. The UE of claim 9, further configured to:
receive, from the base station, an uplink grant scheduling uplink feedback; and
to transmit the feedback, the UE is configured to transmit the feedback in accordance with the uplink grant.

18. The UE of claim 17, wherein to receive the uplink grant, the UE is configured to:
receive the uplink grant including an uplink downlink assignment index (UL-DAI) corresponding to a sum of a total number of data transmissions of the multiple MBSs scheduled during the time period.

19. The UE of claim 18, wherein the sum is a first sum, the UE further configured to:
determine, based on (i) the first sum and (ii) a second sum of a total number of successfully received data transmissions of the multiple MBSs, a number of data transmissions not successfully received; and
include, in the feedback, an indication of the number of data transmissions not successfully received.

20. The UE of claim 9, wherein to receive the plurality of downlink assignments, the UE is configure to:
unscramble a plurality of cyclic redundancy checks (CRCs) received with the respective plurality of downlink assignments using a temporary identifier associated with the MBS.

21. The UE of claim 9, wherein to transmit the feedback, the UE is configured to:
transmit a hybrid automatic repeat request (HARQ) codebook including a sub-codebook for the MBS, the sub-codebook including the indication.
